(19) United States
(12) Patent Application Publication
(10) Pub. No.: US 2012/0244863 A1
(43) Pub. Date: Sep. 27, 2012

(54) SYSTEM AND METHOD FOR DYNAMIC SERVICE OFFERING BASED ON AVAILABLE RESOURCES

(75) Inventors: John M. Burnette, Seattle, WA (US); Jeffrey P. Harrang, Sammamish, WA (US); David B. Gibbons, Redmond, WA (US)

(73) Assignee: Opanga Networks Inc., Seattle, WA (US)

(21) Appl. No.: 13/429,146

(22) Filed: Mar. 23, 2012

Related U.S. Application Data
(60) Provisional application No. 61/466,629, filed on Mar. 23, 2011.

(51) Int. Cl. G06F 15/173; H04W 36/08; H04W 72/04

(52) U.S. Cl. 455/436; 455/452.1; 709/226

(57) ABSTRACT

A system and method is disclosed to dynamically alter service offerings to a user based on the available network resources. As network resources are diminished, the end user will see less available services so as to avoid diminished network performance. If network performance improvements, the system detects the improved network recourse availability and provides more offerings to the end user.

### BACKGROUND OF THE INVENTION

1. Field of the Invention

The present disclosure is directed generally to network service providers and, more particularly, to a system and method for dynamic service offering based on available resources.

2. Description of the Related Art

As the online service market continues to grow, network resources are beginning to constrain service availability and quality. However, many online services today are deployed with little consideration given to the availability of network capacity (e.g., bandwidth, base-station timeslot, etc.). In a situation where network operators are also the service providers, they often give more thought to the service and deploy in such a way as to not exceed their resources. In either scenario, the result is a blanket-style service offering in which every consumer has access to the same options, features, and experience. The non-operator providers offer the same service to all, which in turn will work for some users and not work for others. The operators will also offer the same service, but usually with diminished quality such that the service will work for everyone. The trade-off then becomes a matter of quality versus reachable users.

Therefore, it can be appreciated that there is a significant need for a system and method that can allocate offering to subscribers based on available resources. The present disclosure provides to this and other advantages as will be apparent from the following detailed description and accompanying figures.

### BRIEF DESCRIPTION OF THE SEVERAL VIEWS OF THE DRAWING(S)

FIG. 1 illustrates an exemplary embodiment of a system architecture constructed in accordance with the present disclosure.

FIG. 2 illustrates a cycle of service ordering, delivery, and network monitoring.

FIG. 3 illustrates an example of prediction of available resources in adjacent cells of a wireless network.

FIG. 4 illustrates a service-based cell hand-over.

FIG. 5 is a flow chart illustrating an exemplary embodiment of a system constructed in accordance with the present disclosure.

### DETAILED DESCRIPTION OF THE INVENTION

The trade-off of quality versus reachable users has been discussed above. Accepting this trade-off is not necessary, however. If the service had knowledge of available network resources then it would be possible to adjust the service offering so that users with low network resources would not unnecessarily constrain users with high network resources. In addition, users would not be frustrated attempting to consume services that the network was unable to deliver. Service offering, as used herein, refers to the services available to a particular user that use networks to deliver content needed by the services. For example, service offerings could include movies (standard definition movies and high definition movies), television programming, music videos, audio file, and the like. The term service offering refers generically to the types of services that a user may find available from a telco company, cable company, movie channel, web server, or the like. The term service offering should be broadly viewed to cover the delivery of all types of data files, particularly multimedia files, that a user may wish to download.

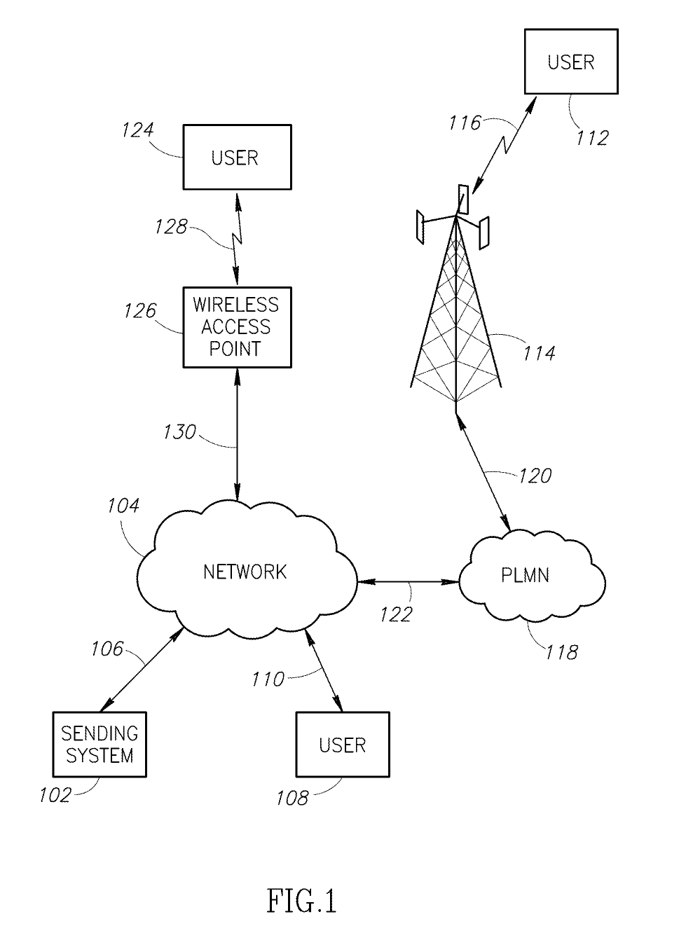

FIG. 1 illustrates an exemplary architecture of a system 100 to illustrate an implementation of the present disclosure. FIG. 1 illustrates sending system 102, such as a server containing a plurality of multimedia files. The sending system 102 generically represents one or more computing devices capable of storing data files, such as multimedia data files, and sending them to requesting computing devices. While FIG. 1 only illustrates a single sending system 102, those skilled in the art will appreciate that the sending system 102 may be implemented as a plurality of servers distributed on a network. In addition, the actual data files to be transferred may be stored within one or more of the sending systems 102 or in a remote location accessible by the sending system. The sending system 102 is coupled to a network 104 via a communication link 106. In a typical embodiment, the network 104 is a wide-area network (WAN), and may be a private WAN, or a public WAN, such as the Internet.

Also illustrated in FIG. 1 is a User 108, which generically represents a computing or communication device capable of receiving and processing the type of data files that may be transmitted by the sending system 102. For example, the User 108 can be a computer (e.g., desktop, laptop, computing tablet, or the like), a smart television, digital video recorder, cable box, or the like. The User 108 is coupled to the network 104 via a communication link 110. Those skilled in the art can appreciate that the communication link 110 represents a number of different possible connections between the User 108 and the network 104. For example, the User 108 could be connected on a fixed wire line, optical fiber, coaxial cable, or the like. In operation, the User 108 may request a particular resource from the sending system 102 via the network 104. As will be discussed in greater detail below, the services available to the User 108 are dependent upon the available network resources. For example, the User 108 may be connected to the network 104 via a digital subscriber link (DSL connection). In one example, a DSL user may be far from the Central Office and thus unable to receive sufficient bandwidth to support HD movie delivery, whereas another DSL user close to the Central Office may find that the available network resources will support HD movie delivery.

Also illustrated in FIG. 1 is a User 112, which generically represents a wireless computing device capable of receiving and processing the type of files that may be available from the sending system 102. For example, the User 112 could be a portable or fixed computer having a wireless modem connection, a smart phone or other cellular-type device, or the like. The User 112 is coupled to a base station 114 via a wireless communication link 116. In turn, the base station 114 is coupled to a service provider network, such as a public land mobile network (PLMN) 118 via a backhaul 120. Those skilled in the art will appreciate that the base station 114 generically represents various types of wireless service provider networks that may be available. The specific implementation of the base station 114 depends on the communication protocol of the PLMN 118 and the User 112. For example, the wireless service provider could operate with 3G, 4G, LTE, CDMA, w-CDMA, WiMAX, WiFi, or the like.

In operation, the User 112 may request a particular resource from the sending system 102 via the PLMN 118 and the network 104. As will be discussed in greater detail below, the services available to the user 112 are dependent upon the available network resources. This includes resources of the network 104, the PLMN 118, and even the base station 114.

Finally, FIG. 1 also illustrates a User 124, which is coupled to a wireless access point 126 via a wireless communication 128. The User 124 generically represents a computing or communication device capable of receiving and processing the type of data files that may be sent by the sending system 102. For example, the User 124 can be a fixed computer, portable computer, computing tablet, smart television, digital video recorder, or the like. The User 124 may also represent a smart phone or other cellular device with a secondary transceiver, such as, by way of example, WiFi. The wireless access point 126, in turn, is coupled to the network 104 via a communication link 130. The communication links 106, 110, 122, and 130 may be implemented in a variety of known fashions, such as a hard wired communication link, microwave, optical, or combinations thereof. The system 100 is not limited by the specific implementation of the various communication links. However, a slow communication link is indicative of more limited network resources and may result in fewer service offerings.

The wireless access point 126 generically represents wireless access points, such as WiMAX, WiFi, or the like. In operation, the User 124 may request a particular resource from the sending system 102 via the network 104 and the wireless access point 126. As will be discussed in greater detail below, the services available to the user 124 are dependent upon the available network resources. This includes the resources of the network 104 and even the available resources of the wireless access point 126. Thus, the system 100 will determine the available resources for the various types of users (e.g., the Users 108, 112, and 124) and customize the available service offerings based on the available resources.

Consider the scenario where a service is deployed over a wireless network—fixed or mobile. Each base station (e.g., the base station 114) within the network would be deployed to cover some geographic area. The base station is divided into multiple sectors. The household or subscriber density within the different sectors of that base station 114 will vary and thus usage patterns and data consumption between the sectors will vary as well. In the case that sector 1 is heavily loaded, the resources available to a new service will be minimal. However, if sector 2 is not very loaded then resources for a new service are much more available. In accordance with the present teachings, the service would then offer more options and features to users in sector 2 and less to users in sector 1 such that available resources are maximized but not exceeded in each of the sections. This means that by analyzing the available network resources more carefully, service offerings can be adapted to maximize bandwidth utilization and maximize the amount of revenue generated from the network.

Suppose the service offerings include the distribution of video assets. In the previous scenario, users in sector 1 may be presented a small library of standard definition videos available for download by the system 100. However, users in sector 2 may be presented a much larger library of standard definition videos as well as a library of high definition (HD) videos from which to choose. Because HD video requires more bandwidth resources to deliver, only users in sector 2 can get them. The service as a whole does not have to make the quality versus consumer reach trade-off because it is reaching ALL users and presenting the best possible offering (quality) to each user. This means that more of the available resource is used in sector 2 and HD video enables revenue to be created from the surplus capacity that exists there while at the same time the resources in sector 1 are not overpowered or congested through an HD offering.

In an exemplary embodiment the system 100 achieves serving the best offering on a dynamic, autonomous, per network cluster/sector basis.

Autonomous Dynamic Service Offering

The dynamic service offering is made possible by having knowledge of network resource availability. This service depends on having performance data available to it. The data can be provided by systems such as QoS, Opanga Adaptive Bandwidth Management Algorithm (ABMA) delivery technology, among others. Exemplary embodiments of ABMA are described in U.S. Pat. No. 7,500,010 entitled “Adapted File Delivery System and Method,” which is assigned to the assignee of the present application and which is incorporated herein in its entirety.

The service (e.g., the sending system 102 in FIG. 1) receives reports on the network performance and conditions at any time on a link/sector basis. This performance information may include measured link throughput, delivery errors and resends, streaming buffer starvation, carrier to interference ratio, received signal strength, latency, latency variation, link/sector occupancy, screen freeze frequency (if streaming), and other relevant metrics used to measure or control wired and wireless communication. The various receivers (e.g., the Users 108, 112, and 124 in FIG. 1) issue reports to servers (e.g., the sending system 102) so that the senders can alter their presented service offerings to the end user based on the networks' current or predicted condition. Thus, the service has real-time metrics on each sector of the base station 114 or the WAN 104 and can make a determination of what level of service offering can be presented to consumers.

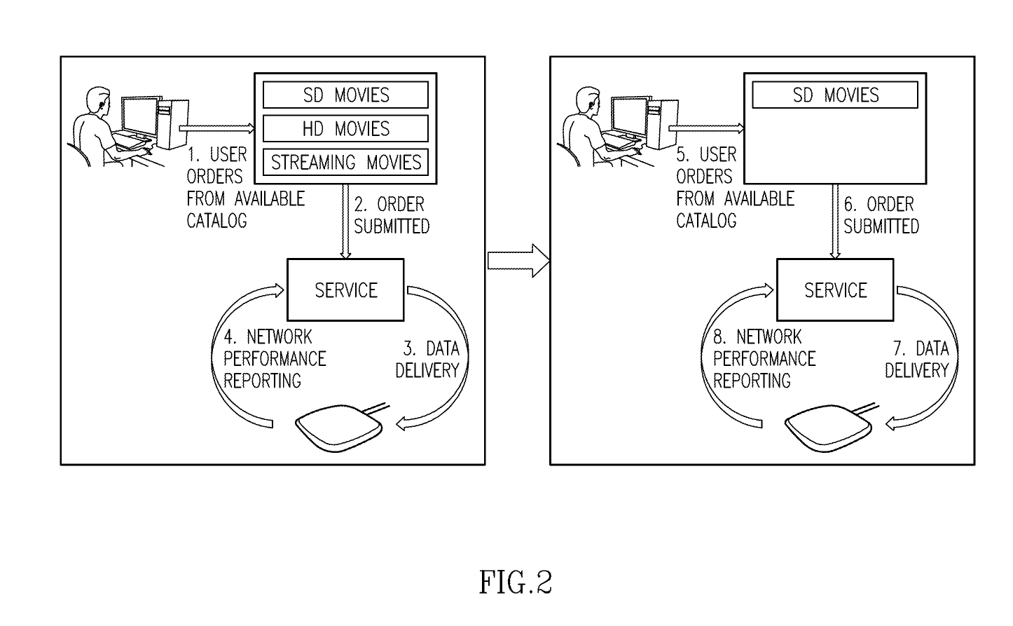

A specific example would be in the case of a video offering, is illustrated in FIG. 2. In this example, a service (e.g., the sending system 102 of FIG. 1) starts with a “high” performance assumption, shown on the left side of FIG. 2, and presents a video catalog to users within a sector of the base station 114. A user (e.g., the User 112) browses the catalog and selects (1) a movie for download. This catalog may be available via an application, web browser, etc. The user's order is then submitted (2) to the service for delivery. The service begins delivery (3) to the consumer end device and receives network performance reports (4) as the video is delivered. For this example, assume the network performance was not optimal. The service would then dynamically adjust so that the next time the user browses the video catalog (5), shown on the right side of FIG. 2, they are presented with fewer choices (e.g., SD only). This cycle would repeat and the service would continuously and autonomously adapt. If the performance is good then the service presents an expanded catalog to the users. If the service quality is low, then the service may limit the catalog, all without operator interaction. If the service qualify improves, then the service may expand its catalog, all without operator interaction.

In an alternative embodiment, the dynamic service offering is made possible based on the knowledge of the predicted likelihood of network resource availability. For example, if a user has operated on the serving network previously, the service offerings that could be expected currently at the attachment point of the serving network or the time of attachment to the serving network could be used to predict the dynamic service offering that might be expected.

In yet another alternative embodiment, the dynamic service offering to a first user is made possible based on the current or past knowledge of network resource availability of one or a plurality of other users at similar locations or times of network access to the first user. For example, if other users are operating or have operated at similar attachment points to the serving network for the first user, the service offering that the other user received could be used to predict the dynamic service offering that might be expected for the first user.

Wired Vs Wireless

Additional considerations can be made depending on whether the service is a fixed line or wireless (mobile) offering. In the case of fixed line, such as the User 108 in FIG. 1, it is likely that the quality of the communication link within a network sector will be fairly static. Even so, the system 100 can monitor the pathway between the sending system 102 and the User 108 via the network 104 and adjust the service offerings as necessary. Network congestion and maximum throughput of the communication pathway between the sending system 102 and the User 108 can be determined using techniques, such as those, for example, disclosed in the above-referenced U.S. Pat. No. 7,500,010. However, in the case of a mobile user, such as the User 112 in FIG. 1, the service offering may change much more often as the user moves between wireless cells. In this scenario, the system 100 may implement additional logic to determine the services to offer.

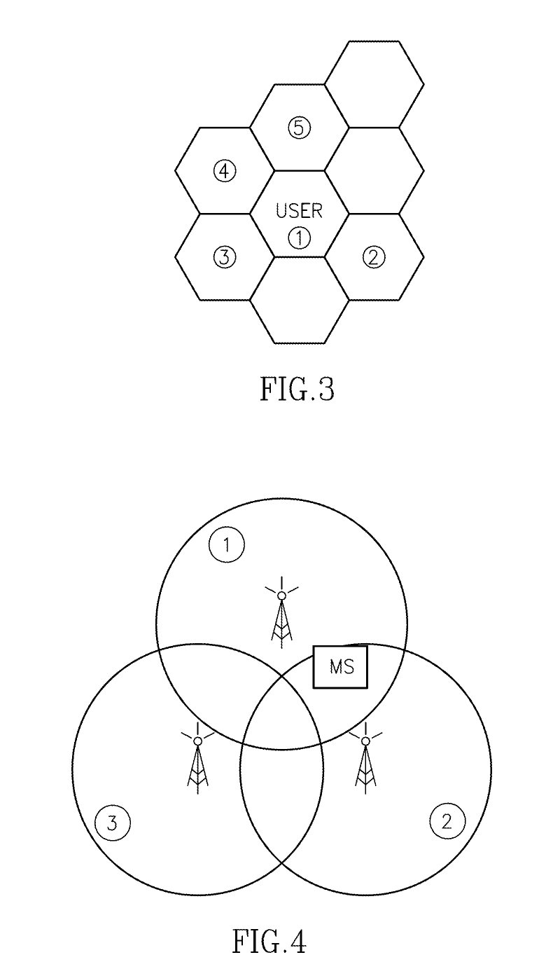

As an example, adjusting service offerings in a mobile system one method would be to average the level of signal quality ratings reported by adjacent cells to influence the service offerings presented to the cell in question. From FIG. 3 the mobile user (e.g., the User 112 in FIG. 1) is in cell 1. In anticipation that the mobile user will move to a new cell, the system 100 may take the signal quality rating reports from other mobile users in some adjacent cells (e.g., cells 2, 3, 4, and 5) and use those reports in conjunction with reports from cell 1 to come up with an overall service offering for the User 112 in cell 1. This helps ensure that if User 112 does move to a new cell, the system 100 may still be able to deliver the service offerings that were presented in the prior cell.

Continuing the example, the system 100 may track the user movement and can use that information to weight the signal quality rating reports from adjacent cells. For example, if the User 112 user moved from cell 2 to cell 1 and is moving toward cell 4, then the system 100 may give higher weight to the cell 3/4/5 signal quality rating reports when formulating a decision on what services to offer when the User 112 moves to a new cell.

Service-Based Cell Hand-Over

In wireless networks load balancing is a feature that networks (e.g., the PLMN 118 in FIG. 1) use to control mobile hand-overs between cells. The load balancing is often done based on the number of current users in a cell versus available capacity. However, currently no service offering logic is included in the hand-over decision. That is, the conventional PLMN 118 does not consider the service offerings to the mobile station when making a cell hand-over decision. The dynamic service offering information described above can also be used in this case. In fact, knowing that a consumer will use a particular service could greatly influence the network's decision to hand-over to a new cell.

For example, suppose a mobile station (MS) in FIG. 4, such as the User 112, is leaving cell 2 and entering cell 1. As the MS enters the overlapping region between cells 1 and 2 a typical network service would decide, based on number of users and available capacity, which cell the MS should link to. In the proposed solution, the system 100 also provides data utilization characteristics (based on service offerings) to the network. So in this example, suppose the typical network would hand the MS to cell 1. However, the system 100 is aware of the subscriber's current service offering. It is also aware of the typical data pattern for these service offerings. Given this information, the system 100 may determine that, although there is some amount of resource available in cell 1 it may not be sufficient to service the anticipated services offerings requested by the user of the MS. So in this case, the network would bias the handover decision weighting to preferentially leave the user in cell 2. Thus, the system 100 provides information to a cellular service provider to assist in a service-based cell hand-over.

In another example, the decision may be not whether to remain with cell 2 or switch to cell 1, but rather which sector in cell 1 should receive the hand-off of the MS. In the example of FIG. 4 where the MS is moving from cell 2 to cell 1, the previous example was a decision point of whether or not to switch cells. However, switching cells is often a matter of radio signal strength and there may not be the option of whether or not to hand off the MS to cell 1. However, the MS may be capable of communicating with more than one sector upon entering cell 1. The same service-based analysis described above can be used to determine the best sector for the hand-off with the MS. One possible sector may have a slightly better signal strength, but the other possible sector has better available network resources and thus may be a better choice for the MS. Thus, the system 100 provides information to the cellular service to assist in the selection of the sector based on service offerings.

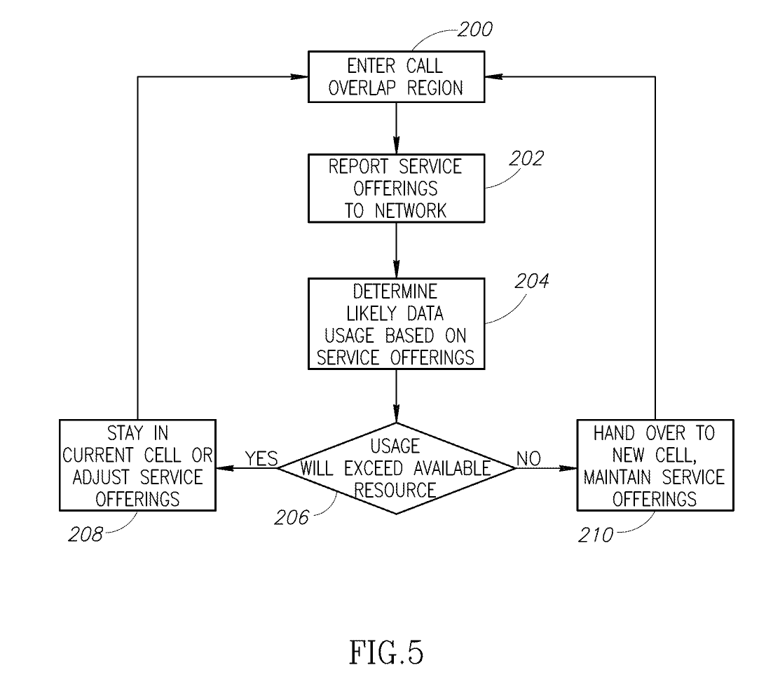

The flow diagram of FIG. 5 illustrates the decision making process for hand over based on service offerings and the associated data usage. At step 200, the mobile station (e.g., the User 112 in FIG. 1) enters an overlap region between two cells. In step 202, the current service offering levels are reported to the network (e.g., the PLMN 118 in FIG. 1). The current service offerings may be reported by the User 112 or by the presently serving base station.

In step 204, the PLMN 118 determines the likely data usage for the mobile station based on the available service offerings. In decision 206, the network determines whether the likely data usage will exceed the available resources. If the likely data usage will exceed the available resources, the result of decision 206 is YES and, in step 208, the system can either have the MS stay in its current cell or adjust the service offerings as the MS switches to a new cell. Following step 208, the system returns to the beginning of the process at step 200.

If the likely data usage will not exceed the available resources, the result of decision 206 is NO and, in step 210, the system hands the MS over to the next cell and maintains the current service offerings. Following the hand-over in step 210, the system returns to the beginning of the process at step 200. Thus, the wireless network can make decisions based on current service offerings to a user, the likely data utilization of that user, and the analysis of available resources within the network to maintain the current service offerings to the user.

Thus, the system provides techniques for preserving the network such that service offerings are consistent with the available network resources so that instantaneous offerings to various users will never exceed the network capability. Premium service opportunities, such as HD multimedia files are dynamically offered when the network resources are available thus maximizing the potential monetary return to a network operator. Furthermore, network operators do not have to manage the service offerings. With the system 100, the best possible offerings will be made available throughout the network, including wireless networks, based on the available resources. In a wireless system, the available service offerings can be altered on a per sector basis based on the available network resources in that sector. Thus, the overall consumer experience is constrained by the resources of that sector, or a cluster and not by the entire network performance. Furthermore, the system 100 offers a smarter network hand-over technique that is enabled by including current service offerings in known data patterns for those service offerings when making hand-over decisions.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A method comprising:
automatically determining a level of available network resources to deliver data files from a sending system to a receiving system to thereby determine an initial level of available network resources; and
determining which of a plurality of services to offer to the receiving system based at least in part on the initial level of available network resources.

2. The method of claim 1 wherein automatically determining a level of available network resources to deliver data files is repeated and automatically determines that a current level of available network resources is less than the initial level of available network resources, the method further comprising automatically reducing the plurality of services to offer to the receiving system based at least in part on the current level of available network resources.

3. The method of claim 1 wherein automatically determining a level of available network resources to deliver data files is repeated and automatically determines that a current level of available network resources is greater than the initial level of available network resources, the method further comprising automatically increasing the plurality of services to offer to the receiving system based at least in part on the current level of available network resources.

4. The method of claim 1 wherein the receiving system is a wireless receiving system coupled to a base station in a first cell via one of a plurality of base station sectors, the method further comprising automatically determining a level of available network resources in each of the plurality of sectors and determining which of the plurality of services to offer to the wireless receiving system is based at least in part on the level of available network resources for the one of the plurality of base station sectors with which the wireless receiving system is communicating.

5. The method of claim 4 wherein the wireless receiving system is located in an overlapping coverage area between the base station in the first cell and a base station in a second cell, the method further comprising automatically determining whether to hand off the wireless receiving system to the base station in the second cell or to keep the wireless receiving system coupled to the base station in the first cell based at least in part on the plurality of services presently offered to the wireless receiving system coupled to the base station in the first cell and the plurality of services presently that could be offered to the wireless receiving system if handed off to the base station in the second cell.

6. The method of claim 5, further comprising automatically determining a level of available network resources in the second cell and determining which of the plurality of services that could be offered to the wireless receiving system based at least in part on the level of available network resources in the second cell.

7. The method of claim 4 wherein the wireless receiving system is located in an overlapping coverage area between the base station in the first cell and a base station in a second cell, the method further comprising automatically determining whether to hand off the wireless receiving system to the base station in the second cell or to keep the wireless receiving system coupled to the base station in the first cell based at least in part on a user preferences for selection of offerings.

8. A system comprising:
a server configured to store a plurality of offerings to a recipient;
a network resource processor configured to determine available resources for delivery of data from the server to the recipient;
a controller configured to control which of the plurality of offerings to provide to the recipient based on the determined available resources wherein the controller provides less available offerings to the recipient if there are less determined available resources and more available offerings to the recipient if there are more determined available resources.

9. The system of claim 8 wherein the controller is further configured to dynamically reduce the number of available offerings to the recipient if the network resource processor determines there is a reduction in the determined available resources.

10. The system of claim 8 wherein the controller is further configured to dynamically increase the number of available offerings to the recipient if the network resource processor determines there is an increase in the determined available resources.
